(19) United States
(12) Patent Application Publication
(10) Pub. No.: US 2013/0039588 A1
(43) Pub. Date: Feb. 14, 2013

(54) IMAGE PROCESSING METHOD AND APPARATUS FOR TAMPER PROOFING

(71) Applicants: Ji LI, Beijing (CN); Xiaowei Yang, Beijing (CN)

(72) Inventors: Ji LI, Beijing (CN); Xiaowei Yang, Beijing (CN)

(73) Assignee: Sony Corporation, Tokyo (JP)

(21) Appl. No.: 13/559,985

(22) Filed: Jul. 27, 2012

(30) Foreign Application Priority Data
Aug. 12, 2011 (CN) 201110234927.8

(51) Int. Cl. G06K 9/46

(52) U.S. Cl. 382/201

(57) ABSTRACT

An image processing method and apparatus for tamper proofing are proposed. The method includes: acquiring a first robust feature representation of a first set of robust feature points for an original image and a second robust feature representation of a second set of robust feature points for an image to be detected, respectively; matching the first robust feature representation with the second robust feature representation so as to acquire mismatching feature points; and determining whether the image to be detected has been tampered with relative to the original image based on a distribution characteristic of the mismatching feature points. With the embodiments of the invention, the distribution characteristic of the mismatching feature points is analyzed based on the robust feature representations of the original image and the image to be detected, so that conventional operations on the image can be distinguished effectively from tampering in the image with sufficient robustness.

### CROSS REFERENCE TO RELATED APPLICATIONS

This application claims the benefit of Chinese Application No. 201110234927.8, filed on Aug. 12, 2011, the disclosure of which is incorporated herein by reference.

### FIELD OF THE INVENTION

The present invention generally relates to the field of image processing, more specifically to image verification and integrity protection, and in particular to an image processing method and apparatus for tamper proofing.

### BACKGROUND OF THE INVENTION

Image data are vulnerable to tampering, and are likely to contain an error or to be lost during transmission or storage. Some existing technical measures allow for modification of the content of an image, and it is hard to identify the modification. In many applications, the user needs to check the integrity of an image, to make sure that the image has not been tampered with or lost, or not contain an error. For example, when an image is used in court as evidence, it is required to prove that the image has not been tampered with. As another example, the accuracy of medical images such as the image material in an electronic medical record has to be protected.

In the prior art, normally digital signatures are used for protecting the integrity of data. However, for an image, normal operations such as compression, rotation, scaling and blurring do not affect its content and hence cannot be considered as tampering. In order to protect the integrity of an image, it is desired to provide a technique that is robust to normal operations on the image. Digital watermarking, especially robust watermarking, has certain robustness and can protect the image from being tampered with. For example, Chinese patent applications No.CN101866477A and No.CN1658223 provide digital watermarking for image verification. However, digital watermarking requires the integrity information to be spread and embedded in the original image or video, which alters the original data to some extent, and then digital watermarking is not suitable for many application cases.

In comparison with digital watermarking, robust hashing (also referred to as perceptual hashing, semantic hashing or image hashing) does not require information to be embedded in the original data, and has a wider range of applications. Moreover, because no information is embedded in the original image, perceptual hashing has higher robustness. Generally, robust hashing extracts robust features from the image, and compresses them to generate a robust hash value. The robust features change little under normal operations on the image, but change significantly in the case of malicious tampering with the image. For more information regarding perceptual hashing, please refer to “Perceptual Hashing” (Xiamu Niu and Yuhua Jiao, Chinese Journal of Electronics, vol. 36, no. 7, 2008) and “Recent development of perceptual image hashing” (Suozhong Wang and Xinpeng Zhang, Journal of Shanghai University (English Edition), vol. 11, no. 4, pp. 323-331, 2007).

However, existing robust hashing algorithms normally can only identify image tampering in a large area of an image. For tampering in a small area, existing robust hashing algorithms cannot identify such tampering for the purpose of robustness. A reference titled “Attacking some perceptual image hash algorithm” (W. Li and B. Preneel, Proceedings of International Conference on Multimedia Computing and Systems/International Conference on Multimedia and Expo—ICME (ICMCS), 2007) analyzes some well-known perceptual hashing algorithms and concludes that they fail to detect tampering in a small region of the image. However, it is often that the small area of an image carries important semantic information, e.g., indicative information such as numbers on a license plate in a traffic surveillance picture, a trademark on a product and a flag over a building. Such a shortcoming makes these perceptual hashing algorithms not suitable for the image verification and integrity protection.

Chinese patent application No.CN101079101 discloses a robust hashing image verification method based on Zernike moments, which has certain robustness to such operations as rotation, JPEG compression, noising and filtering on an image, and can distinguish malicious operations such as cutting and pasting. However, it ignores tampering in a small area in the interest of robustness.

Chinese patent application No.CN1663276 discloses a robust signature for signal verification in which the DC value of an image block is used as the feature. The signature as obtained has good robustness to compression and can locate the tampering. However, due to the limited robustness the selected feature, this method has little robustness to the operations including rotation, scaling and the like.

### SUMMARY OF THE INVENTION

In view of the status of the prior art, it is desired to provide a simple, efficient image processing method and apparatus for tamper proofing.

According to an embodiment of the present invention, it is provided an image processing method for tamper proofing, including:

acquiring a first robust feature representation of a first set of robust feature points for an original image and a second robust feature representation of a second set of robust feature points for an image to be detected;

matching the first robust feature representation with the second robust feature representation so as to acquire mismatching feature points; and

determining whether the image to be detected has been tampered with relative to the original image based on a distribution characteristic of the mismatching feature points.

According to an embodiment of the present invention, it is also provided an image processing apparatus for tamper proofing, including:

a feature representation acquiring unit configured to acquire a first robust feature representation of a first set of robust feature points for an original image and a second robust feature representation of a second set of robust feature points for an image to be detected;

a matching unit configured to match the first robust feature representation with the second robust feature representation so as to acquire mismatching feature points; and

tamper determining unit configured to determine whether the image to be detected has been tampered with relative to the original image based on a distribution characteristic of the mismatching feature points.

The image processing method for tamper proofing according to the embodiment of the present invention can be applied to the publication of news pictures. With this method, it can be determined whether a news picture involved in publication has been tampered with relative to an original news picture.

The image processing method for tamper proofing according to the embodiment of the present invention can also be applied to an intelligent traffic surveillance system. With this method, it can be determined whether a traffic violation picture submitted as evidence has been tampered with relative to an original traffic violation picture.

According to an embodiment of the present invention, it is also provided a program product including machine-readable codes stored thereon, and the machine-readable codes when read and executed by a machine, can cause the machine to carry out the foregoing image processing method for tamper proofing.

According to an embodiment of the present invention, it is also provided a storage medium having carried therein machine-readable codes that, when read and executed by a machine, can cause the machine to carry out the foregoing image processing method for tamper proofing.

By analyzing the distribution characteristic of mismatching feature points based on the robust feature representations for the original image and the image to be detected, the image processing technique for tamper proofing according to the embodiments of the present invention can distinguish tampering with an image from normal operations on the image, is sufficiently robust and can correctly identify whether the original image has been tampered with, especially whether there is tampering in a small area. Therefore, good robustness and accurate tampering identification can be both achieved.

Specific implementations of the embodiments of the present invention will be described hereinafter, which are for the illustrative purpose only and shall not be interpreted as limiting the present invention.

### BRIEF DESCRIPTION OF THE DRAWINGS

The above and other objects, characteristics and advantages of the present invention will become more apparent from the following description of the embodiments with reference to the accompanying drawings, where the same or like function components or steps are indicated by the same or like reference numerals. Of the accompanying drawings:

FIG. 1 is a simplified schematic flow chart illustrating an image processing method for tamper proofing according to an embodiment of the present invention;

FIGS. 2A-2B are schematic diagrams illustrating an original image and extracted robust feature points for the original image in a specific example;

FIGS. 3A-3C are schematic diagrams illustrating an image obtained from blurring the original image shown in FIG. 2A, extracted robust feature points for the obtained image, and mismatching feature points between the obtained image and the original image shown in FIG. 2B, respectively;

FIGS. 4A-4C are schematic diagrams illustrating an image obtained from compressing the original image shown in FIG. 2A, extracted robust feature points for the obtained image, and mismatching feature points between the obtained image and the original image shown in FIG. 2B, respectively;

FIGS. 5A-5C are schematic diagrams illustrating an image obtained from rotating the original image shown in FIG. 2A, extracted robust feature points for the obtained image, and mismatching feature points between the obtained image and the original image shown in FIG. 2B, respectively;

FIGS. 6A-6C are schematic diagrams illustrating an image obtained from tampering in a small region with the original image shown in FIG. 2A, extracted robust feature points for the obtained image, and mismatching feature points between the obtained image and the original image shown in FIG. 2B, respectively;

FIGS. 7A-7C are schematic diagrams illustrating an image obtained from blurring and tampering with the original image in a small area shown in FIG. 2A, extracted robust feature points for the obtained image, and mismatching feature points between the obtained image and the original image shown in FIG. 2B, respectively;

FIGS. 8A-8C are schematic diagrams illustrating an image obtained from compressing and tampering with the original image in a small area shown in FIG. 2A, extracted robust feature points for the obtained image, and mismatching feature points between the obtained image and the original image shown in FIG. 2B, respectively;

FIGS. 9A-9C are schematic diagrams illustrating an image obtained from rotating and tampering with the original image in a small area shown in FIG. 2A, extracted robust feature points for the obtained image, and mismatching feature points between the obtained image and the original image shown in FIG. 2B, respectively;

FIG. 10 is a simplified block diagram illustrating an image processing apparatus for tamper proofing according to an embodiment of the present invention;

FIG. 11 is a simplified block diagram illustrating a specific implementation of a feature representation acquiring unit included in the image processing apparatus for tamper proofing shown in FIG. 10;

FIG. 12 is a simplified block diagram illustrating a specific implementation of a tamper determining unit included in the image processing apparatus for tamper proofing shown in FIG. 10;

FIG. 13 is a simplified block diagram illustrating another specific implementation of the tamper determining unit included in the image processing apparatus for tamper proofing shown in FIG. 10;

FIG. 14 is a simplified block diagram illustrating still another specific implementation of the tamper determining unit included in the image processing apparatus for tamper proofing shown in FIG. 10;

FIG. 15 is a simplified block diagram illustrating another specific implementation of the tamper determining unit included in the image processing apparatus for tamper proofing shown in FIG. 10; and

FIG. 16 is a simplified block diagram illustrating an exemplary structure of a personal computer can be used in the information processing device according to the embodiments of the present invention.

### DETAILED DESCRIPTION OF THE EMBODIMENTS

The embodiments of the invention will be described hereinafter in conjunction with the accompanying drawings. It is noted that only those apparatus structures and/or processing steps closely related to the technical solution of the present invention are shown in the figures to avoid unnecessarily obscuring the present invention. Other details that are not closely related to the present invention are omitted. The same or like components or parts are indicated by the same or like reference numerals.

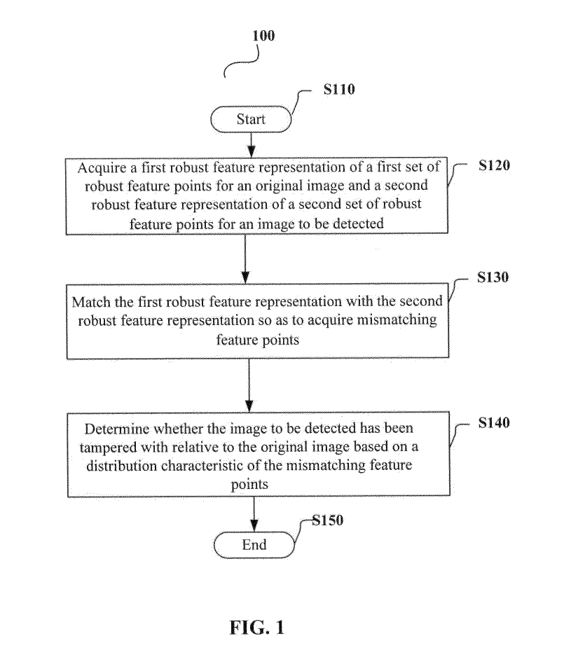

FIG. 1 is a simplified flow chart illustrating an image processing method 100 for tamper proofing according to an embodiment of the present invention. As shown in FIG. 1, the method 100 starts at step S110. At step S120, a first robust feature representation of a first set of robust feature points for an original image and a second robust feature representation of a second set of robust feature points for an image to be detected are acquired, respectively. At step S130, the first robust feature representation is matched with the second robust feature representation so as to acquire mismatching feature points. At step S140, it is determined whether the image to be detected has been tampered with relative to the original image based on a distribution characteristic of the mismatching feature points.

Specific implementations of the steps included in the method 100 shown in FIG. 1 will be describe below in detail in conjunction with the accompanying drawings.

The “image to be detected” here refers to the image to be determined whether it has been tampered with relative to the original image. It is required that the robust feature representation for the original image and the robust feature representation for the image to be detected maintain the characteristics of the feature points in the images to the fullest extent, and are insensitive (i.e., robust) to normal operations on the images such as rotation, blurring and compression but sensitive to tampering in the images. Therefore, any feature representation that meets the above-mentioned requirements can be used as the robust feature representation. In a specific implementation, e.g., robust hash values for the original image and the image to be detected may be obtained by hashing technology, as the robust feature representations for these images.

As for the first robust feature representation for the original image and the second robust feature representation for the image to be detected acquired at step S120, these robust feature representations may be received externally; alternatively, these robust feature representations may be generated for the original image and the image to be detected in the processing of the method 100. As a matter of course, it is also applicable to have one of the first robust feature representation and the second robust feature representation received externally and have the other generated in the processing of the method 100.

In a specific implementation where the first robust feature representation and/or the second robust feature representation is generated in the processing of the method 100, the first robust feature representation and/or the second robust feature representation may be generated through extracting robust feature points from the image. Specifically, this implementation may include: extracting the first set of robust feature points for the original image and processing the extracted first set of robust feature points to acquire the first robust feature representation corresponding to the first set of robust feature points, and/or, extracting the second set of robust feature points for the image to be detected and processing the extracted second set of robust feature points to acquire the second robust feature representation corresponding to the second set of robust feature points.

As for extracting robust feature points from the original image and/or the image to be detected, any suitable robust feature extracting technique, whether it is known or to be developed in the future, can be applied. For example, any of SIFT, SURF and Harris corner may be used as the robust feature point to be extracted. The SIFT (Scale Invariant Feature Transformation, refer to, e.g., Lowe, D.: Object recognition from local scale-invariant features. 1999), SURF (Speed Up Robust Feature, refer to, e.g., Bay, H., Tuytelaars, T., Gool, L. V.: Surf: Speeded up robust features. In: In ECCV. (2006)) and Harris corner (refer to, e.g., Monga, V., Evans, B. L.: Robust perceptual image hashing using feature points. In: Proceedings of the IEEE International Conference on Image Processing. 2004) and the like are all features robust to normal operations on images.

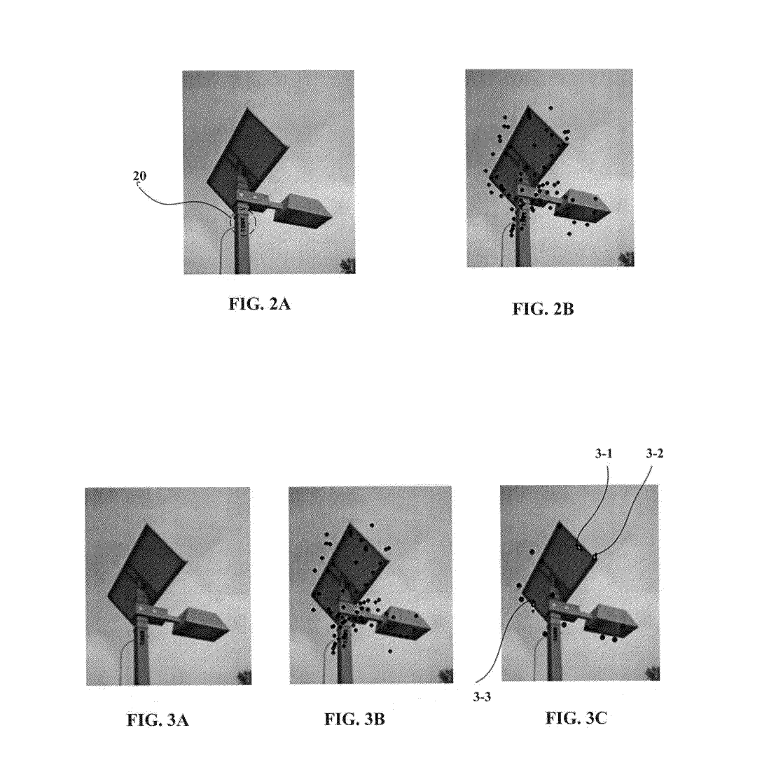

FIGS. 2B, 3B, 4B, 5B, 6B, 7B, 8B and 9B respectively illustrate the robust feature points extracted for the original image and the robust feature points extracted for the images to be detected, i.e., the images obtained from blurring the original image, from compressing the original image, from rotating the original image, from tampering with the original image in a small area, from blurring and tampering with the original image in a small area, from compressing and tampering with the original image in a small area, and from rotating and tampering with the original image in a small area. Dark dots in respective figures indicate the extracted robust feature points.

Then, the extracted robust feature points are processed to acquire the robust feature representation corresponding to the robust feature points, e.g., a robust hash value.

Moreover, in actual applications, the robust feature points extracted from the image may sometimes contain a large amount of data. To facilitate subsequent processing, the extracted robust feature points may be quantized before acquiring the robust hash value.

A specific example of quantizing the extracted robust feature points will be given below.

Each of the robust feature points extracted from the image (original image or image to be detected) according to the technique above may be a one-dimensional or multidimensional vector. Cluster analysis is performed on the extracted robust feature points. Such cluster analysis can be implemented, for example, using various known clustering methods, and the details for the cluster analysis are therefore omitted. Then, for each of the clusters, an average of each component for all the feature points in the cluster is calculated. For example, for a certain cluster, an average for all the first components of the feature points in the cluster is calculated, an average for all the second components of the feature points in the cluster is calculated, and so forth. For each component of each feature point in all the clusters, if the component is larger than the average in relation to the component, the component is quantized to “1”; otherwise, it is quantized to “0”. It can be seen that two quantization intervals are set for each component according to the calculated average for the each component, with one quantization interval above the average and the other one quantization interval below or equal to the average. A more specific example is given below. For example, SURF feature points are extracted as the robust feature points, and the robust feature points are compressed with a method which quantizes each component to 1 bit by setting two quantization intervals for the component. Then, each of the SURF feature points is a 128-dimensional vector and is quantized to 128 bits. With this method, a robust feature point extracted from the original image or the image to be detected can be quantized and compressed into a binary sequence. The quantization is based on the average corresponding to each component of the feature points, thus maintains the characteristics of the feature points to a great extent, and significantly reduces the data amount of the feature points and facilitates subsequent processing for acquiring the robust feature representation (e.g., robust hash value) corresponding to the robust feature points, thereby lowering the system computing load.

In an alternative implementation, each component may be quantized to at least two bits. Specifically, at least two quantization intervals are set according to the above obtained average for each component, and each of the quantization intervals may correspond to a binary value of more than one bit which can be regarded as a quantization value corresponding to the quantization interval. For example, three quantization intervals may be set according to the average for each component, with the first quantization interval being below or equal to the average, the second quantization interval being larger than the average but less than 1.3 times the average, and the third quantization interval being larger than 1.3 times the average, etc.; hence, a binary value of more than one bit is assigned to each of the quantization intervals. For each component of a feature point, if the component falls in a certain quantization interval, the component is quantized to the more than one bit corresponding to the quantization interval.

As can be seen, with more quantization intervals, the obtained robust hash value will become closer to the original robust feature point, which improves the accuracy of the subsequent matching but increases the length of the robust hash value. Therefore, it is a trade-off between the accuracy of image processing and the system load to select an appropriate quantization method, and the specific quantization method can be determined according to actual needs.

As described above, each robust feature point is quantized and compressed into a binary sequence, however, the embodiments of the present invention are not limited to the specific implementation. The robust feature point can be quantized to any kind of digital sequence. It would also be appreciated that any other quantization or compression method which has little impact on the robustness provided by the robust feature points can be applied to the embodiments of the present invention, so that robustness and the capability of identifying tampering in a small area are both achieved in conjunction with the subsequent processing.

After the digital sequence has been obtained by performing the compression and quantification on the robust feature points, the compressed digital sequence may be used directly as the final robust hash values; alternatively, the compressed digital sequence may further be processed, e.g., by encoding, to generate the final robust hash value. The processing of generating the robust hash value from the compressed digital sequence can be implemented with various conventional hashing techniques, and the details of such processing are omitted here for the sake of conciseness.

It would be appreciated that if the data amount of the extracted robust feature points is not so large, the extracted robust feature points may be used directly for acquiring the robust feature representations (e.g., the robust hash values) thereof without the processing of quantification and compression mentioned above.

After the robust feature representations for the original image and the image to be detected have been acquired from the foregoing processing, matching is performed on these robust feature representations so as to acquire mismatching feature points. The matching can be implemented with various existing matching techniques. For example, the mismatching feature points may be found by comparing the robust feature representations one point after another; or, the robust feature representations may be compared as a whole, e.g., based on the Hamming distance between the code sequences which are used as the robust feature representations, so as to obtain the mismatching feature points.

After the mismatching feature points have been acquired, it can be determined whether the image to be detected has been tampered with relative to the original image based on a distribution characteristic of the mismatching feature points. For example, the distribution characteristic of the mismatching feature points may be the discrete degree of the mismatching feature points.

In a specific implementation, the discrete degree of the mismatching feature points may be represented, for example, by a cluster density of the mismatching feature points. Some examples below will illustrate how to calculate the cluster density of the mismatching feature points.

As an example, cluster analysis is performed on the mismatching feature points. Such cluster analysis can be performed, for example. by using mean-shift clustering method based on the distances between the feature points. As a common clustering method, mean-shift is essentially an adaptive method which finds the peak value using gradient ascent. When mean-shift is used for the cluster analysis, the number of clusters does not need to be specified in advance. Mean-shift finds a cluster center by iteration in the direction of the positive gradient of a probability density. For more information about mean-shift, please refer to “Mean shift: A robust approach toward feature space analysis” (Dorin Comaniciu, Peter Meer, et al., IEEE Transactions on Pattern Analysis and Machine Intelligence, Vol. 24, No. 5, p603-619.2002). As a matter of course, the embodiments of the present invention are not limited to any specific clustering method, and any suitable clustering method can be used.

After the cluster analysis has been completed, the discrete degree of the mismatching feature points is calculated. The discrete degree indicates whether the mismatching feature points are gathered in a small number of clusters or scattered in a large number of clusters. Generally, tampering with an image, especially tampering with in a small area of the image, will result in a low discrete degree of the mismatching feature points; on the other hand, normal operations on an image will result in a high discrete degree of the mismatching feature points because these normal operations normally affect the whole image. In view of the above, tampering with an image and normal operations on the image can be distinguished from each other by setting a suitable threshold. Furthermore, identification of tampering in a small area of the image can be ensured by appropriately adjusting the threshold. For example, as described above, the discrete degree can be determined by calculating the cluster density.

In a specific implementation of the embodiment of the present invention, various methods for calculating the cluster density are given below according to the general definition of density: density=weight/area.

According to a specific example of calculating the cluster density, the distance of each point in a cluster to the center of the cluster to which the point belongs may be calculated by:

D_{i,j}=\sqrt{(x_{i,j}−x_{i,0})²+(y_{i,j}−y_{i,0})²} (Equation 1)

where, (x_{i,0}, y_{i,0}) represents the coordinates of the center of the i^{th} cluster, (x_{i,j}, y_{i,j}) represents the coordinates of the j^{th} feature point in the i^{th} cluster. The coordinate system can be defined according to any known method, e.g., a Cartesian coordinate system defined in the image plane. A weighted average related to the distances may be calculated by Equation 2 as follows based on the distances and the number of feature points in the clusters, as the cluster density of mismatching feature points, i.e., the total density Den:

$$Den = \frac{m}{n} {\sum }_{i = 1}^{n} {\sum }_{j = 0}^{m - 1} ( {D}_{i , j} * {K}_{i , j} ) \qquad ( Equation 2 )$$

where n represents the number of the clusters, m represents the number of the feature points in a cluster, both m and n being positive integers, and i and j represent the index of a cluster and the index of a mismatching feature point in a cluster, respectively. K_{i,j} represents a weight of the distance D_{i,j}, and can be determined through limited number of experiments or based on empirical values. In this calculation method, the weighted value D_{i,j}*K_{i,j} for each distance is used as the weight of the feature vector corresponding to the distance, and a vector density of the vector is obtained by dividing the weight by the number of all clusters (equivalent to the area), n. The cluster density is obtained by dividing the sum of the weights of all feature points (i.e., feature vectors) in all clusters by the number of all clusters (equivalent to the area), n. As can be seen from Equation 2, the total density Den represents a weighted average related to the distances of the mismatching feature points (i.e., feature vectors), and is considered as the cluster density.

If the cluster density obtained according to Equation 2 is larger than a predetermined threshold, it is determined that the image to be detected has been tampered with. Otherwise, it is determined that the image to be detected has not been tampered with or only normal operations have been performed on the original image. The threshold can be determined according to actual needs. For example, the threshold can be determined through a limited number of experiments or based on empirical values, and the details of the determination are omitted for the sake of conciseness. Furthermore, preferably, identification of tampering in a small area of the image can be ensured by appropriately setting the threshold.

According to another specific example of calculating the cluster density, K-means may be used to perform the cluster analysis on the mismatching feature points. The distance of each of the mismatching feature points to the center of a cluster to which the mismatching feature point belongs, D_{i,j}, may be calculated by the above-mentioned Equation 1. Then, a vector density is calculated for each of the clusters and all the calculated vector densities are averaged among all the feature points, and a total density Den is given by:

$$Den = \frac{m}{n} {\sum }_{i = 1}^{n} {\sum }_{j = 0}^{m - 1} {D}_{i , j}^{2} \qquad ( Equation 3 )$$

where, n represents the number of the clusters, m represents the number of the feature points in a cluster, both m and n being positive integers, and i and j represent the index of a cluster and the index of a mismatching feature point in a cluster, respectively. In comparison with Equation 2, Equation 3 replaces D_{i,j}*K_{i,j} with D_{i,j}² in the calculation of cluster density, thereby simplifying the selection of K_{i,j}. That is, this is an adaptive, weighting process, with the distance D_{i,j} itself being the weight coefficient of the distance D_{i,j}. As can be seen, similar to the case of Equation 2, by Equation 3, a weighted average related to the distances is obtained as the cluster density.

The presence of tampering can be determined according to whether the total density Den is larger than a predetermined threshold, and identification of tampering in a small area of the image can be ensured by appropriately setting the threshold. The specific processing is similar to that of the foregoing example, and the details thereof are omitted for the sake of conciseness.

K-means is a commonly used clustering method in the art. For more information of K-means, please refer to “A K-Means Clustering Algorithm” (J. A. Hartigan and M. A. Wong, Applied Statistics, Vol. 28, No. 1, p100-108, 1979). In this example, the threshold may be set similarly to the foregoing example, and the details of the setting are omitted for the sake of conciseness.

According to still another specific example of calculating the cluster density, after the distances of the mismatching feature points, D_{i,j}=\sqrt{(x_{i,j}−x_{i,0})²+(y_{i,j}−y_{i,0})²}, have been obtained according to the above Equation 1, the total density Den may be calculated according to Equation 4 below:

$$Den = \frac{1}{m * n} {\sum }_{i = 1}^{n} {\sum }_{j = 0}^{m - 1} \frac{1}{{D}_{i , j}^{2}} \qquad ( Equation 4 )$$

In Equation 4, the parameters m, n, i and j have the same meanings as in Equations 2 and 3. In the calculation method according to present example, the weight of the feature vector corresponding to the distance Rd is regarded as the unit weight “1”, and then 1/D_{i,j} represents the distribution of the unit weight on a one-dimensional distance D_{i,j} (equivalent to the area in the two-dimensional case), i.e., the vector density. 1/D_{i,j}² represents a result obtained by performing a self-adaptive weighting process on 1/D_{i,j}, i.e., with a weight coefficient being 1/D_{i,j}. Similarly, the weight of each cluster is regarded as the unit weight “1”, and then 11m represents the density corresponding to the each cluster. Therefore, the total density Den obtained by the above-mentioned Equation 4 represents a weighted average related to the distances of feature points and is regarded as the final cluster density. In this example, the way the threshold is set, the processes of determining the presence of tampering according to whether the total density Den is larger than the threshold, and identifying tampering in a small area of the image are similar to those in the foregoing two examples, and the details thereof are therefore omitted for the sake of conciseness.

As can be seen, by each of Equations 1-4, a weighted average related to the distances of at least a part of the mismatching feature points in all the clusters is obtained according to respective distances of each mismatching feature point to the center of the cluster to which the mismatching feature point belongs, as the cluster density corresponding to all the clusters. It is noted that, in the calculation methods based on, for example, the above-mentioned Equations 2 and 3, the cluster density can be obtained based on all the mismatching feature points in all the clusters. However, in the method based on the above-mentioned Equation 4, any cluster having only one feature point has to be removed because the denominator of Equation 4 is distance D_{i,j}, which is 0 in such cluster and will lead to an error in the calculation of the total cluster density Den.

In addition, as an alternative implementation of representing the discrete degree of the mismatching feature points, after completion of the above mentioned clustering, the number of mismatching feature points within a region which is centered on a cluster center and has a predetermined size may be used to indicate the discrete degree of the mismatching feature points. And a smaller number of mismatching feature points within the region of the predetermined size indicates a higher discrete degree of mismatching feature points. Similarly, tampering with an image and normal operations on the image can be distinguished from each other by setting a suitable threshold. That is, if the number of mismatching feature points within the region of the predetermined size is larger than the threshold, it is determined that the image to be detected has been tampered with. Otherwise, it is determined that the image to be detected has not been tampered with or only normal operations have been performed on the original image. Similarly, the threshold can be determined according to actual needs, e.g., through a limited number of experiments or based on empirical values, and the details of the setting are omitted for the sake of conciseness. Furthermore, preferably, identification of tampering in a small area of the image can be ensured by appropriately setting the threshold. In a specific implementation, the region of the predetermined size may be a region having a unit area and centered on a cluster center.

The above gives some examples for determining whether the image to be detected has been tampered with relative to the original image according to the discrete degree of the obtained mismatching feature points. Other alternative examples in which it is determined whether the image to be detected has been tampered with relative to the original image according to the distribution characteristic of the mismatching feature points will be given below.

In an alternative example, the distribution of all robust feature points is determined according to the robust feature points extracted from the original image, for example by a statistical method. Similarly, the distribution of mismatching feature points in the image to be detected can be determined. The determined distribution of the mismatching feature points is compared with the distribution of the robust feature points in the original image, and if the result of the comparison indicates the two distributions are close to each other (e.g., the difference between the two is within a predetermined range), it is determined that the image to be detected has not been tampered with relative to the original image; otherwise, it is determined that the image to be detected has been tampered with.

In another alternative example, the distribution characteristic of the mismatching feature points may be learned in advance through some samples, so that a distribution characteristic model of the mismatching feature points in the case of normal image processing operations without tampering and/or a distribution characteristic model of the mismatching feature points in the case of tampering can be established. The normal image processing operations may include compression, rotation, scaling, blurring and the like performed on the image. In the subsequent detection, it is determined whether the image to be detected has been tampered with by comparing with the learned models. For example, the distribution characteristic of the mismatching feature points may be compared with the distribution characteristic model of the mismatching feature points in the case of normal image processing operations without tampering, and if the difference between them is within a predetermined range, then it is determined the image to be detected has not been tampered with relative to the original image; otherwise, it is determined the image to be detected has been tampered with. Alternatively, the distribution characteristic of the mismatching feature points may be compared with the distribution characteristic model of the mismatching feature points in the case of tampering, and if the difference between them is within a predetermined range, then it is determined the image to be detected has been tampered with relative to the original image; otherwise, it is determined the image to be detected has not been tampered with. Generally, in order to draw the conclusion as to whether the image to be detected has been tampered with, the comparison can be made with any one of the distribution characteristic model of the mismatching feature points in the case of normal image processing operations without tampering and the distribution characteristic model of the mismatching feature points in the case of tampering. However, in practice, it still exists such situation in which the comparison needs to be made with both of the distribution characteristic models mentioned above. For example, if the required accuracy for tampering detection is high, the results from the comparisons made with the above-mentioned two kinds of distribution characteristic models may be cross checked for corroboration. If the conclusions obtained from the two results contradict each other, it shows that the detection of the mismatching feature points, the establishment of the models or the like may fail to meet a certain requirement. And then, further optimization, such as re-detection of the mismatching feature points and reestablishment of the models may be performed according to actual situation. Details of the optimization are not essential for illustrating the implementation of the embodiments of the present invention, and thus are omitted. Therefore, the advantageous double check can be achieved by comparing with both the distribution characteristic model of the mismatching feature points in the case of normal image processing operations without tampering and the distribution characteristic model of the mismatching feature points in the case of tampering.

The determination of whether the image to be detected has been tampered with relative to the original image according to the discrete degree of the mismatching feature points and the result of the determination will be described in detail in conjunction with the accompanying drawings.

For example, as shown in FIG. 3C, there are multiple mismatching feature points in the image to be detected obtained from blurring the original image. The mismatching feature points are classified to three clusters by performing cluster analysis on the mismatching feature points. As shown in FIG. 3C, there are three cluster centers denoted by “3-1”, “3-2” and “3-3”, and the other dark dots indicate the mismatching feature points. A large discrete degree of the mismatching features points is obtained by, for example, the processing shown in the above mentioned Equation 2, 3 or 4 based on the clusters, i.e., the value calculated by Equation 2, 3 or 4 is larger than a predetermined threshold. Therefore, it is determined that the image shown in FIG. 3C has not been tampered with relative to the original image, and the large discrete degree of the mismatching feature points indicates a normal operation on the original image.

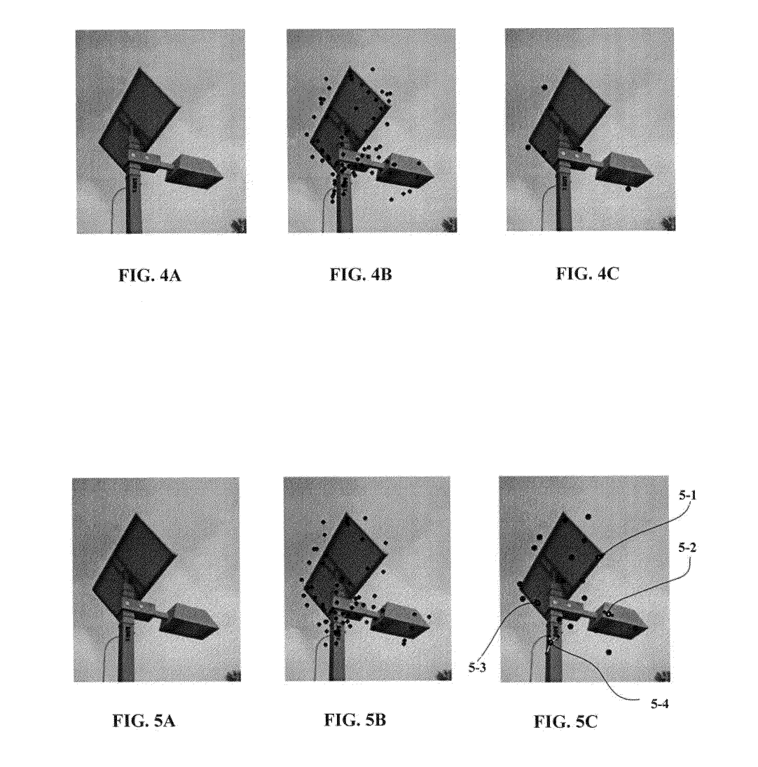

As shown in FIG. 4C, there are multiple mismatching feature points in the image to be detected obtained from compressing the original image. No cluster is formed by performing cluster analysis on the mismatching feature points. The dark dots in the figure indicate the mismatching feature points. Since no cluster is formed, it can be concluded that the discrete degree of the mismatching feature points is large. Therefore, it is determined directly that the image shown in FIG. 4C has not been tampered with relative to the original image, and the image has been subjected to a normal operation.

For example, as shown in FIG. 5C, there are multiple mismatching feature points in the image to be detected obtained from rotating the original image. The mismatching feature points are classified to three clusters by performing cluster analysis on the mismatching feature points. As shown in FIG. 5C, there are four cluster centers denoted by “5-1”, “5-2”, “5-3” and “5-4”, and the other dark dots indicate the mismatching feature points. A large discrete degree of the mismatching features points is obtained by, for example, the processing shown in the above mentioned Equation 2, 3 or 4 based on the clusters, i.e., the value calculated by Equation 2, 3 or 4 is larger than a predetermined threshold. Therefore, it is determined that the image shown in FIG. 5C has not been tampered with relative to the original image, and the large discrete degree of the mismatching feature points indicates a normal operation on the original image.

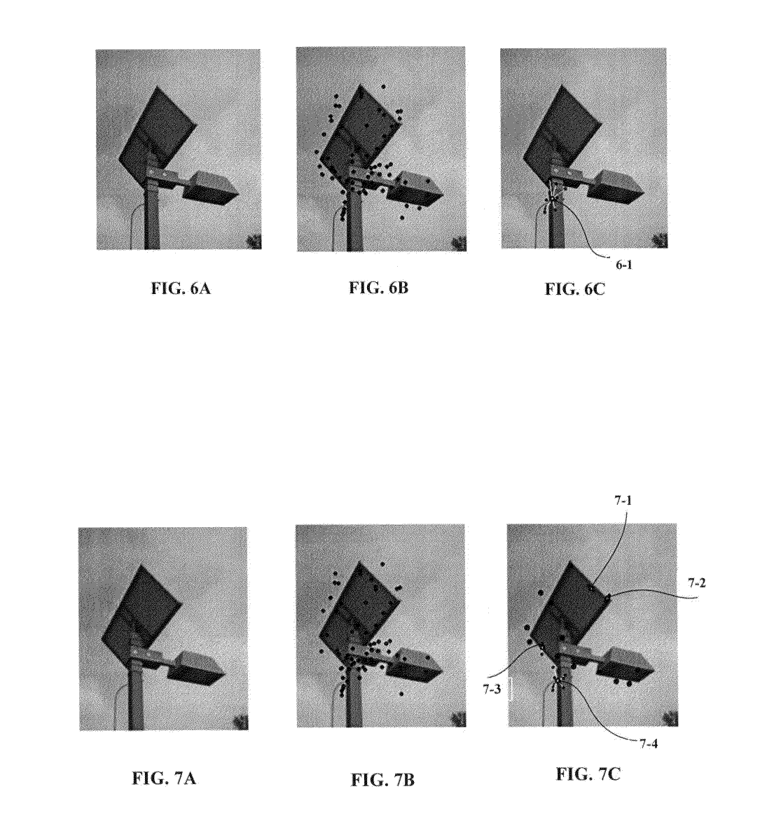

As shown in FIG. 6C, there are multiple mismatching feature points in the image to be detected obtained from tampering with the original image in a small area. The mismatching feature points are classified to one cluster by performing cluster analysis on the mismatching feature points. As shown in the figure, there is one cluster center denoted by as “6-1”, and the other dark dots indicate the mismatching feature points. A small discrete of the mismatching feature points is obtained by, for example the processing shown in the above mentioned Equation 2, 3 or 4 based on the cluster, i.e., the value calculated by Equation 2, 3 or 4 is smaller than a predetermined threshold. Therefore, it is determined that the image shown in FIG. 6C has been tampered with relative to the original image, and the discrete degree of the mismatching feature points is small, that is, the cluster density is high.

As shown in FIG. 7C, there are multiple mismatching feature points in the image to be detected obtained from blurring and tampering with the original image in a small area. The mismatching feature points are classified to four clusters by performing cluster analysis on the mismatching feature points. As shown in the figure, there are four cluster centers denoted by as “7-1”, “7-2”, “7-3” and “7-4”, and the other dark dots indicate the mismatching feature points. A small discrete degree of the mismatching feature points is obtained by, for example the processing shown in the above mentioned Equation 2, 3 or 4 based on the clusters, i.e., the value calculated by Equation 2, 3 or 4 is smaller than a predetermined threshold. Therefore, it is determined that the image shown in FIG. 7C has been tampered with relative to the original image, and the discrete degree of the mismatching feature points is small, that is, the cluster density is high.

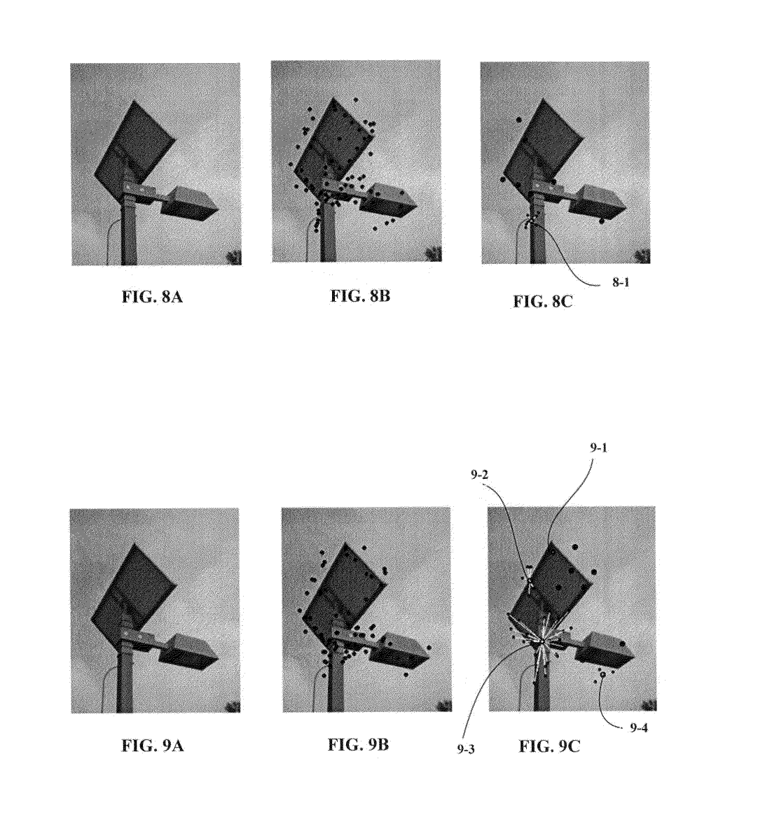

As shown in FIG. 8C, there are multiple mismatching feature points in the image to be detected obtained from compressing and tampering with the original image in a small area. The mismatching feature points are classified to one cluster by performing cluster analysis on the mismatching feature points. As shown in the figure, there is one cluster center denoted by as “8-1”, and the other dark dots indicate the mismatching feature points. A small discrete degree of the mismatching feature points is obtained by, for example the processing shown in the above mentioned Equation 2, 3 or 4 based on the cluster, i.e., the value calculated by Equation 2, 3 or 4 is smaller than a predetermined threshold. Therefore, it is determined that the image shown in FIG. 8C has been tampered with relative to the original image, and the discrete degree of the mismatching feature points is small, that is, the cluster density is high.

As shown in FIG. 9C, there are multiple mismatching feature points in the image to be detected obtained from rotating and tampering with the original image in a small area. The mismatching feature points are classified to four clusters by performing cluster analysis on the mismatching feature points. As shown in the figure, there are four cluster centers denoted by as “9-1”, “9-2”, “9-3” and “9-4”, and the other dark dots indicate the mismatching feature points. A small discrete degree of the mismatching feature points is obtained by, for example the processing shown in the above mentioned Equation 2, 3 or 4 based on the clusters, i.e., the value calculated by Equation 2, 3 or 4 is smaller than a predetermined threshold. Therefore, it is determined that the image shown in FIG. 9C has been tampered with relative to the original image, and the discrete degree of the mismatching feature points is small, that is, the cluster density is high.

Those of ordinary skilled in the art would appreciate that, after the mismatching feature points shown in FIGS. 2C, 3C, 4C, 5C, 6C, 7C, 8C and 9C have been acquired, the number of the mismatching feature points within regions which each is centered on a respective cluster center and has a predetermined size may be used to determine whether the image to be detected has been tampered with. For example, if the number of the mismatching feature points within any of the regions is larger than a threshold, it is determined that the image to be detected has been tampered with.

As can be seen from the above, the image processing method for tamper proofing according to the embodiments of the present invention performs cluster analysis on the mismatching feature points and determines whether the image has been tampered with according to the distribution characteristic of the mismatching feature points. Particularly, it is found that, when the discrete degree of the mismatching feature points is used as the determination criterion for the presence of tampering, tampering in a small area of the image results in a low discrete degree while normal operations result in a high discrete degree because they normally affect the whole image. Then, tampering with the image and normal operations on the image can be efficiently distinguished by setting a suitable threshold, and in a preferred embodiment, especially tampering with the image in a small area can be identified. This method improves the ability to identify tampering without losing the robustness, and in a preferred embodiment of the method, the identification of tampering with the image in a small area can be ensured. As discussed above, it is often that a small area of an image carries important semantic information, e.g., indicative information such as numbers on a license plate in a traffic surveillance picture, a trademark on a product and a flag over a building, and therefore, it is of practical significance to correctly identify tampering in such a small area. “A small area” here generally means an area in the image where the tampering cannot be identified or cannot be correctly identified by existing image processing methods. For example, the small area can be an area of a predetermined small size in the image. As a matter of cause, those of ordinary skilled in the art would appreciate that the small area may have other different meanings depending on the application scenarios.

As shown in FIGS. 6A, 7A, 8A and 9A, indicative information 20 (circled by a dotted line) on the standing pole in the original image shown in FIG. 2A has been removed from these figures, and the image processing method for tamper proofing according to the embodiments of the present invention can correctly identify such tampering in the small area.

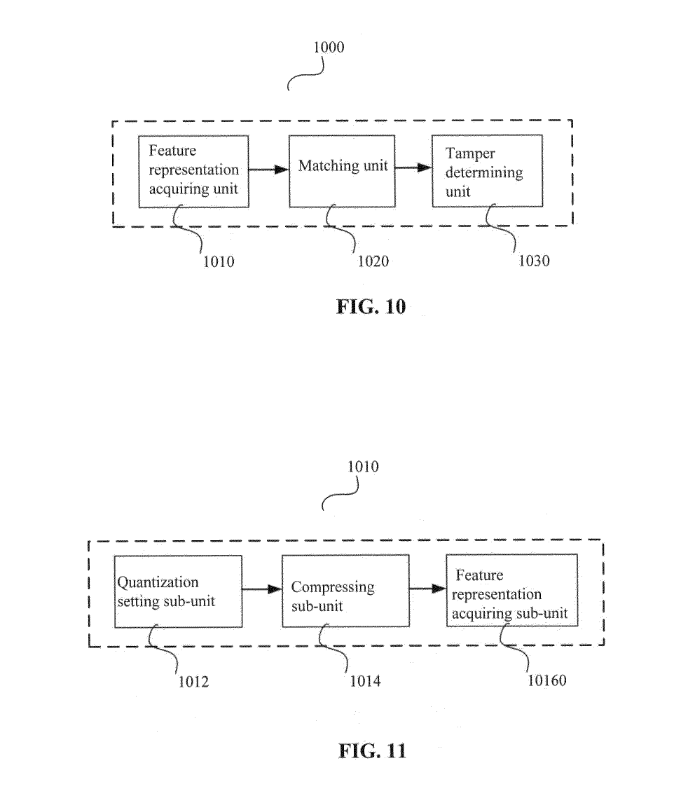

In correspondence to the image processing method mentioned above for tamper proofing, embodiments of the present invention also provide an image processing apparatus for tamper proofing. FIG. 10 is a simplified block diagram illustrating such an apparatus 1000. As shown in FIG. 10, the apparatus 1000 includes: a feature representation acquiring unit 1010, configured to acquire a first robust feature representation of a first set of robust feature points for an original image and a second robust feature representation of a second set of robust feature points for an image to be detected; a matching unit 1020, configured to match the first robust feature representation with the second robust feature representation so as to acquire mismatching feature points; and a tamper determining unit 1030, configured to determine whether the image to be detected has been tampered with relative to the original image based on a distribution characteristic of the mismatching feature points.

As described above, the feature representation acquiring unit 1010 may receive externally the first robust feature representation for the original image and the second robust feature representation for the image to be detected, or may generate on its own the first and second robust feature representations. Alternatively, the feature representation acquiring unit 1010 may receive externally any one of the first and second robust feature representations and generate on its own the other.

In a specific implementation, the first and/or second robust feature representation may be generated by extracting robust feature points of the original image and/or the image to be detected. Specifically, the feature representation acquiring unit 1010 may be configured to generate the first robust feature representation and/or the second robust feature representation by: extracting the first set of robust feature points for the original image and processing the extracted first set of robust feature points to acquire the first robust feature representation corresponding to the first set of robust feature points, and/or, extracting the second set of robust feature points for the image to be detected and processing the extracted second set of robust feature points to acquire the second robust feature representation corresponding to the second set of robust feature points.

In the case where the feature representation acquiring unit 1010 generates on its own the first robust feature representation and/or second robust feature representation, as shown in FIG. 11, according to a specific implementation of the feature representation acquiring unit 1010 included in the apparatus 1000 shown in FIG. 10, the feature representation acquiring unit 1010 includes: a quantization setting sub-unit 1012 configured to perform cluster analysis on the first set of robust feature points and/or the second set of robust feature points, respectively; with respect to each cluster obtained through the cluster analysis, calculate an average corresponding to each component for all the feature points in the each cluster, respectively; and set at least two quantization intervals related to the each component according to the average, with each quantization interval corresponding to a quantization value; a compressing sub-unit 1014 configured to, for each vector of each feature point in the first set of robust feature points and/or the second set of robust feature points, assign the quantization value corresponding to the quantization interval into which the each component falls to said each component, so as to compress the first set of robust feature points and/or the second set of robust feature points, respectively; and a feature representation acquiring sub-unit 1016 configured to generate a first robust hash value of the compressed first set of robust feature points as the first robust feature representation corresponding to the first set of robust feature points, and/or, generate a second robust hash value of the compressed second set of robust feature points as the second robust feature representation corresponding to the second set of robust feature points.

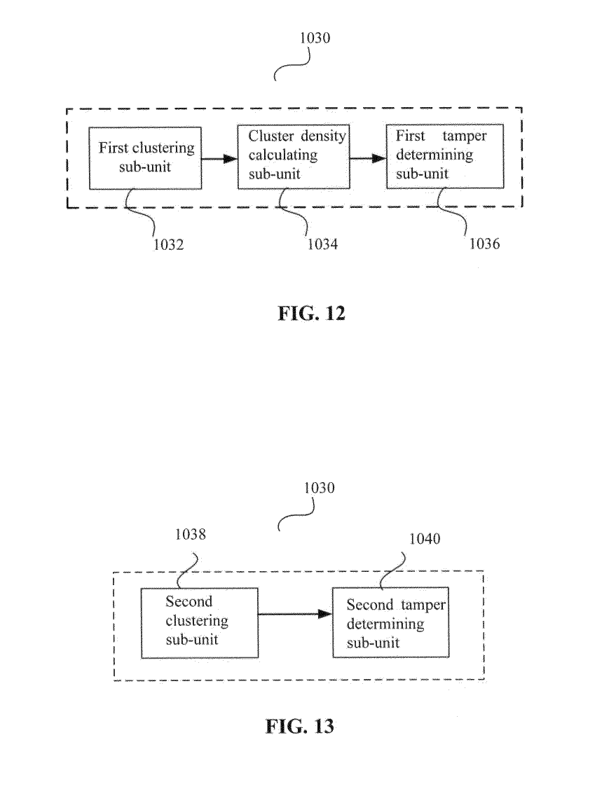

As shown in FIG. 12, in a specific implementation of the tamper determining unit 1030 included in the apparatus 1000 shown in FIG. 10, the tamper determining unit includes: a first clustering sub-unit 1032 configured to perform cluster analysis on the mismatching feature points; a cluster density calculating sub-unit 1034 configured to calculate a cluster density; and a first tamper determining sub-unit 1036 configured to determine that the image to be detected has been tampered with relative to the original image if the cluster density is larger than or equal to a predetermined first threshold. The cluster density calculating sub-unit 1034 can be configured to calculate the cluster density according to, e.g., any of the methods described above based on Equations 1-4.

As shown in FIG. 13, in another specific implementation of the tamper determining unit 1030 included in the apparatus 1000 shown in FIG. 10, the tamper determining unit 1030 includes: a second clustering sub-unit 1038 configured to perform cluster analysis on the mismatching feature points; and a second tamper determining sub-unit 1040 configured to determine that the image to be detected has been tampered with relative to the original image if the clusters obtained by the second clustering sub-unit include at least one cluster in which the number of the mismatching feature points in a region that is centered on the center of the cluster and has a predetermined size is larger than a predetermined second threshold.

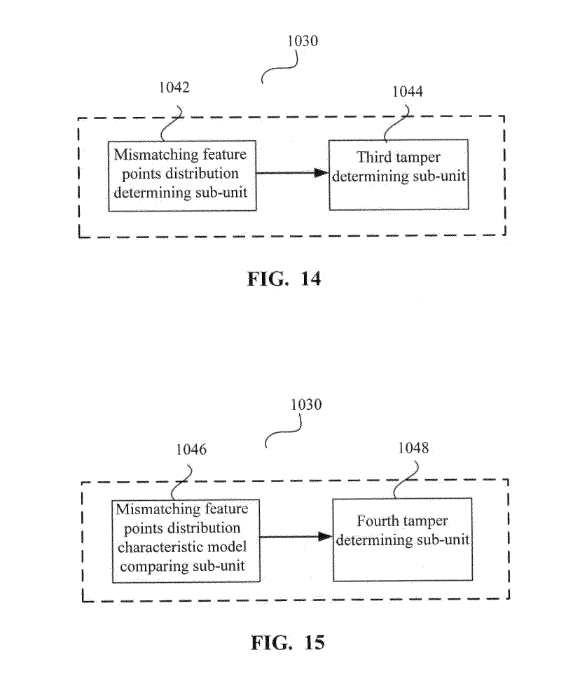

As shown in FIG. 14, in still another specific implementation of the tamper determining unit 1030 included in the apparatus 1000 shown in FIG. 10, the tamper determining unit 1030 includes: a mismatching feature point distribution determining sub-unit 1042, configured to determine a original feature point distribution for the first set of robust feature points in the original image, and to determine a mismatching feature point distribution for the mismatching feature points in the image to be detected; and a third tamper determining sub-unit 1044, configured to compare the original feature point distribution with the mismatching feature point distribution, and to determine that the image to be detected has not been tampered with relative to the original image if the comparison result indicates the difference between the original feature point distribution and the mismatching feature point distribution is within a first predetermined range, and to determine the image to be detected has been tampered with relative to the original image otherwise.

As shown in FIG. 15, in another specific implementation of the tamper determining unit 1030 included in the apparatus 1000 shown in FIG. 10, the tamper determining unit 1030 includes: a mismatching feature point distribution characteristic model comparing sub-unit 1046, configured to compare the distribution characteristic of the mismatching feature points with a distribution characteristic model of mismatching feature points pre-established in the case of normal image processing operations without tampering and/or a distribution characteristic model of mismatching feature points pre-established in the case of tampering; and a fourth tamper determining sub-unit 1048, configured to: determine that the image to be detected has not been tampered with relative to the original image if the difference between the distribution characteristic of the mismatching feature points and the distribution characteristic model of mismatching feature points pre-established in the case of normal image processing operations without tampering is within a second predetermined range, and determine the image to be detected has been tampered with relative to the original image otherwise; and/or, determine that the image to be detected has been tampered with relative to the original image if the difference between the distribution characteristic of the mismatching feature points and the distribution characteristic model of mismatching feature points pre-established in the case of tampering is within a third predetermined range, and determine the image to be detected has not been tampered with relative to the original image otherwise.

For example, the apparatus 1000 shown in each of FIGS. 10-15 and respective components included in the apparatus 1000 may be configured to carry out the image processing method for tamper proofing according to the embodiments of the present invention described in conjunction with FIGS. 1-9, and can provide corresponding technical advantages.

Please refer to the related disclosures provided above for the details, and the descriptions for the details are omitted here for the sake of conciseness.

Due to the above-mentioned characteristics and technical advantages of the image processing technique for tamper proofing according to the embodiments of the present invention, the image processing technique for tamper proofing can be applied to the publication of news pictures in practical application. The publication process of news pictures normally involves various editing operations. News pictures usually contain important yet tiny information pieces such as a flag which identifies the owner's identity. In the publication of such news pictures, news editors can identify and verify whether a news picture has been tampered with using the foregoing image processing technique for tamper proofing, especially identify and verify tampering in a small area, so as to determine whether the news picture meets an integrity requirement.

In another application scenario, the image processing technique for tamper proofing can be applied to integrity protection and verification of violation pictures in an intelligent traffic surveillance system. Traffic administration normally involves taking pictures at the scene of an accident and such pictures could be used as evidences in subsequent procedure. For example, a camera amounted at a crossing may capture a traffic violation picture of a vehicle when the vehicle passes the crossing illegally. In subsequent transmission and storage of the picture, normal operations, such as compression and enlargement may be performed on the picture. License plate information in the traffic violation picture is important but tiny. With the foregoing image processing technique for tamper proofing according to the embodiments of the present invention, it can be ensured that the traffic violation picture, which may be used as evidence in subsequent procedure, has not been tampered with, especially that the important information, e.g. the license plate information in the traffic violation picture, has not been tampered with.

In still another application scenario, the image processing technique for tamper proofing according to the embodiments of the present invention can be applied to Web applications, protecting a photo against tampering. Some search engines support a reverse search function for finding similar photos of an existing photo. This function can be used by Website owners and photographers to find Web sites that use or reprint their photos. In this scenario, those who repost the photo may maliciously tamper with the photo in a small area to alter the semantic information. Existing methods normally cannot identify such malicious tampering in the small area.

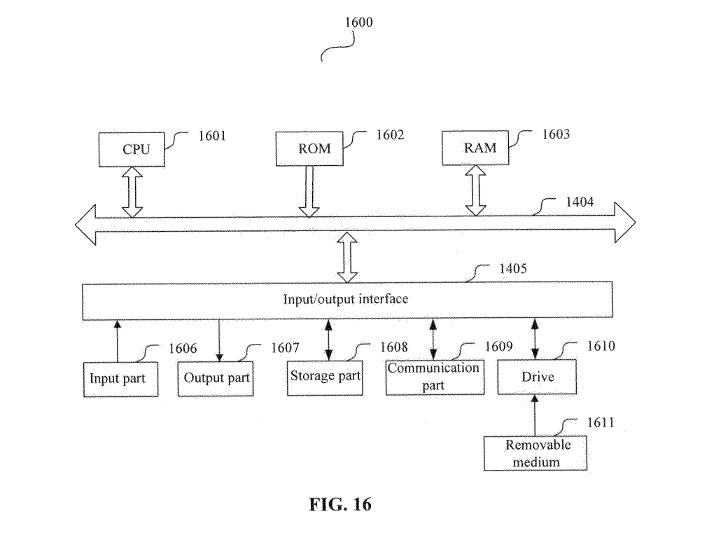

It shall be noted that the respective constituent components of the device, the apparatus and the system and the series of process of the method according to the foregoing respective embodiments of the invention can be implemented in hardware, software and/or firmware. In the event of being implemented in software and/or firmware, a program constituting the software can be installed from a storage medium or a network to a computer with a dedicated hardware structure, e.g., a general-purpose personal computer 1600 illustrated in FIG. 16, which computer can perform various functions, processes, etc., described in the foregoing embodiments when various programs are installed thereon to thereby act as an example of an information processing apparatus capable of performing the image processing method for tamper proofing and image playing method according to the embodiments of the invention.

In FIG. 16, a Central Processing Unit (CPU) 1601 performs various processes according to programs stored in a Read Only Memory (ROM) 1602 or loaded from a storage part 1608 into a Random Access Memory (RAM) 1603. The RAM 1603 also store data required when the CPU 1601 performs the various processes as needed.

The CPU 1601, the ROM 1602 and the RAM 1603 are connected to each other via a bus 1604 to which an input/output interface 1605 is also connected.

The following components are connected to the input/output interface 1605: an input part 1606 including a keyboard, a mouse, etc.; an output part 1607 including a display, e.g., a Cathode Ray Tube (CRT), a Liquid Crystal Display (LCD), etc., a speaker, etc.; the storage port 1608 including a hard disk, etc.; and a communication part 1609 including a network interface card, e.g., an LAN card, a modem, etc. The communication part 1609 performs a communication process over a network, e.g., the Internet.

A drive 1610 is also connected to the input/output interface 1605 as needed. A removable medium 1611, e.g., a magnetic disk, an optical disk, an optic-magnetic disk, a semiconductor memory, etc., can be installed on the driver 1610 as needed, so that a computer program fetched therefrom can be installed into the storage part 1608 as needed.

In the event that the foregoing series of processes are performed in software, a program constituting the software is installed from a network, e.g., the Internet, or a storage medium, e.g., the removable medium 1611.

Those skilled in the art shall appreciate that this storage medium will not be limited to the removable medium 1611 illustrated in FIG. 16 in which the program is stored and which is distributed separately from the device to provide the user with the program. Examples of the removable medium 1611 include a magnetic disk (including a Floppy Disk (a registered trademark)), an optical disk (including Compact Disk-Read Only memory (CD-ROM) and a Digital Versatile Disk (DVD)), an optic-magnetic disk (including a Mini Disk (MD) (a registered trademark)) and a semiconductor memory. Alternatively, the storage medium can be the ROM 1602, the hard disk included in the storage port 1608, etc., in which the program is stored and which is distributed together with the device including the same to the user.

As can be apparent, an embodiment of the invention further discloses a program product on which machine readable instruction codes are stored, wherein the instruction codes upon being read and executed by a machine can make the machine perform the image processing method for tamper proofing according to the foregoing embodiments of the invention. Also another embodiment of the invention further provides a storage medium on which machine readable instruction codes are embodied, wherein the instruction codes upon being read and executed by a machine can make the machine perform the image processing method for tamper proofing according to the foregoing embodiments of the invention.

In the foregoing description of the embodiments of the invention, a feature described and/or illustrated with respect to an implementation can be used identically or similarly in one or more other implementations, or used in combination with or in place of a feature in the other implementation(s).

It shall be noted that the term “including/comprising” and “includes/comprises” as used in this context indicates presence of a feature, an element, a step or a component but does not preclude presence or addition of one or more other features, elements, steps or components. Such ordinal terms as “first”, “second”, etc., do not indicate an order in which features, elements, steps or components defined by these terms are implemented or their degrees of importance but are merely intended to distinguish these features, elements, steps or components from each other for the sake of clarity.

Furthermore, the methods and the processes according to the respective embodiments of the invention will not necessarily be performed in the sequential order described in the specification but can alternatively be performed sequentially in another order, concurrently or separately. Therefore the scope of the invention shall not be limited by the order in which the various methods and processes are performed as described in the specification.

Although the invention has been disclosed above in the description of the embodiments of the invention, it shall be appreciated that the foregoing embodiments and examples are illustrative but not limiting. Those skilled in the art can devise various modifications, adaptations or equivalents to the invention without departing from the spirit and scope of the appended claims. These modifications, adaptations or equivalents shall also be construed as coming into the scope of the invention.

1. An image processing method for tamper proofing, comprising:
acquiring a first robust feature representation of a first set of robust feature points for an original image and a second robust feature representation of a second set of robust feature points for an image to be detected, respectively;
matching the first robust feature representation with the second robust feature representation so as to acquire mismatching feature points; and
determining whether the image to be detected has been tampered with relative to the original image based on a distribution characteristic of the mismatching feature points.

2. The image processing method for tamper proofing according to claim 1, wherein the process of respectively acquiring the first robust feature representation and the second robust feature representation comprises generating the first robust feature representation and/or the second robust feature representation by:
extracting the first set of robust feature points from the original image and processing the extracted first set of robust feature points to acquire the first robust feature representation corresponding to the first set of robust feature points, and/or, extracting the second set of robust feature points from the image to be detected and processing the extracted second set of robust feature points to acquire the second robust feature representation corresponding to the second set of robust feature points.

3. The image processing method for tamper proofing according to claim 2, wherein the process of processing the first set and/or the second set of robust feature points to acquire the first and/or the second robust feature representation comprises:
performing cluster analysis on the first set of robust feature points and/or the second set of robust feature points, respectively; with respect to each cluster obtained through the clustering, calculating an average corresponding to each component for all the feature points in the each cluster, respectively; and setting at least two quantization intervals related to the each component according to the average, with each quantization interval corresponding to a quantization value;
for each component of each feature point in the first set of robust feature points and/or the second set of robust feature points, assigning the quantization value corresponding to the quantization interval into which the each component falls to said each component, so as to compress the first set of robust feature points and/or the second set of robust feature points, respectively; and
generating a first robust hash value of the compressed first set of robust feature points as the first robust feature representation corresponding to the first set of robust feature points, and/or, generating a second robust hash value of the compressed second set of robust feature points as the second robust feature representation corresponding to the second set of robust feature points.

4. The image processing method for tamper proofing according to claim 1, wherein the distribution characteristic of the mismatching feature points comprises the discrete degree of the mismatching feature points.

5. The image processing method for tamper proofing according to claim 4, wherein the process of determining whether the image to be detected has been tampered with relative to the original image based on the distribution characteristic of the mismatching feature points comprises:
performing cluster analysis on the mismatching feature points;
calculating the cluster density according to clusters obtained by the cluster analysis; and
determining that the image to be detected has been tampered with relative to the original image if the cluster density is larger than or equal to a predetermined first threshold.

6. The image processing method for tamper proofing according to claim 5, wherein the cluster density is calculated by:
calculating, for each cluster of the mismatching feature points, a distance of each feature point in the cluster to the center of the cluster; and
obtaining, according to the respective calculated distances, a weighted average related to the distances of at least a part of the feature points in all the clusters as the cluster density corresponding to all the clusters.

7. The image processing method for tamper proofing according to claim 4, wherein the process of determining whether the image to be detected has been tampered with relative to the original image based on the distribution characteristic of the mismatching feature points comprises:
performing cluster analysis on the mismatching feature points; and
determining that the image to be detected has been tampered with relative to the original image if the clusters obtained by the clustering comprise at least one cluster in which the number of the mismatching feature points in a region which is centered on the center of the cluster and has a predetermined size is larger than a predetermined second threshold.

8. The image processing method for tamper proofing according to claim 1, wherein the process of determining whether the image to be detected has been tampered with relative to the original image based on the distribution characteristic of the mismatching feature points comprises:
determining an original feature point distribution condition denoting the distribution condition of the first set of robust feature points in the original image and a mismatching feature point distribution condition denoting the distribution condition of the mismatching feature points in the image to be detected; and
comparing the original feature point distribution condition with the mismatching feature point distribution condition, and if the result of the comparison indicates that the difference between the original feature point distribution condition and the mismatching feature point distribution condition is within a first predetermined range, determining that the image to be detected has not been tampered with relative to the original image; otherwise, determining that the image to be detected has been tampered with relative to the original image.

9. The image processing method for tamper proofing according to claim 1, wherein the process of determining whether the image to be detected has been tampered with relative to the original image based on the distribution characteristic of the mismatching feature points comprises:
comparing the distribution characteristic of the mismatching feature points with a distribution characteristic model of mismatching feature points pre-established in the case of normal image processing operations without tampering and/or a distribution characteristic model of mismatching feature points pre-established in the case of tampering;
if the difference between the distribution characteristic of the mismatching feature points and the distribution characteristic model of mismatching feature points pre-established in the case of normal image processing operations without tampering is within a second predetermined range, determining that the image to be detected has not been tampered with relative to the original image; otherwise, determining that the image to be detected has been tampered with relative to the original image; and/or
if the difference between the distribution characteristic of the mismatching feature points and the distribution characteristic model of mismatching feature points pre-established in the case of tampering is within a third predetermined range, determining that the image to be detected has been tampered with relative to the original image; otherwise, determining that the image to be detected has not been tampered with relative to the original image.

10. An image processing apparatus for tamper proofing, comprising:
a feature representation acquiring unit configured to acquire a first robust feature representation of a first set of robust feature points for an original image and a second robust feature representation of a second set of robust feature points for an image to be detected, respectively;
a matching unit configured to match the first robust feature representation with the second robust feature representation so as to acquire mismatching feature points; and
a tamper determining unit configured to determine whether the image to be detected has been tampered with relative to the original image based on a distribution characteristic of the mismatching feature points.

11. The image processing apparatus for tamper proofing according to claim 10, wherein the feature representation acquiring unit is configured to generate the first robust feature representation and/or the second robust feature representation by:
extracting the first set of robust feature points from the original image and processing the extracted first set of robust feature points to acquire the first robust feature representation corresponding to the first set of robust feature points, and/or, extracting the second set of robust feature points from the image to be detected and processing the extracted second set of robust feature points to acquire the second robust feature representation corresponding to the second set of robust feature points.

12. The image processing apparatus for tamper proofing according to claim 11, wherein the feature representation acquiring unit comprises:
a quantization setting sub-unit configured to perform cluster analysis on the first set of robust feature points and/or the second set of robust feature points, respectively; with respect to each cluster obtained by the cluster analysis, calculate an average corresponding to each component for all the feature points in the each cluster, respectively; and set at least two quantization intervals related to the each component according to the average, with each quantization interval corresponding to a quantization value;
a compressing sub-unit configured to, for each component of each feature point in the first set of robust feature points and/or the second set of robust feature points, assign the quantization value corresponding to the quantization interval into which the each component falls to said each component, so as to compress the first set of robust feature points and/or the second set of robust feature points, respectively; and
a feature representation acquiring sub-unit configured to generate a first robust hash value of the compressed first set of robust feature points as the first robust feature representation corresponding to the first set of robust feature points, and/or, generate a second robust hash value of the compressed second set of robust feature points as the second robust feature representation corresponding to the second set of robust feature points.

13. The image processing apparatus for tamper proofing according to claim 12, wherein:
the quantization setting sub-unit is configured to set, according to the average corresponding to each component of each feature point in the first set of robust feature points and/or the second set of robust feature points, a first quantization interval above the average and a second quantization interval below or equal to the average, respectively, with both of the first and second quantization intervals being related to the each component; and
the compressing sub-unit is configured to compress the first set of robust feature points and/or the second set of robust feature points, respectively, by:
for each component of each feature point in the first set of robust feature points and/or the second set of robust feature points, if the value of the component falls into the first quantization interval related to the component, quantizing the component to 1; otherwise, quantizing the component to 0.

14. The image processing apparatus for tamper proofing according to claim 10, wherein the distribution characteristic of the mismatching feature points comprises the discrete degree of the mismatching feature points.

15. The image processing apparatus for tamper proofing according to claim 14, wherein the tamper determining unit comprises:
a first clustering sub-unit configured to perform cluster analysis on the mismatching feature points;
a cluster density calculating sub-unit configured to calculate the cluster density according to clusters obtained by the first clustering sub-unit; and
a first tamper determining sub-unit configured to determine that the image to be detected has been tampered with relative to the original image if the cluster density is larger than or equal to a predetermined first threshold.

16. The image processing apparatus for tamper proofing according to claim 15, wherein the cluster density calculating sub-unit is configured to calculate the cluster density by:
calculating, for each cluster of the mismatching feature points, the distance of each feature point in the cluster to the center of the cluster; and
obtaining, according to the respective calculated distances, a weighted average related to the distances of at least a part of the feature points in all the clusters as the cluster density corresponding to all the clusters.

17. The image processing apparatus for tamper proofing according to claim 16, wherein the cluster density Den is calculated in any one of the following equations:
$$Den = \frac{m}{n} {\sum }_{i = 1}^{n} {\sum }_{j = 0}^{m - 1} ( {D}_{i , j} * {K}_{i , j} ) ;$$
$$Den = \frac{m}{n} {\sum }_{i = 1}^{n} {\sum }_{j = 0}^{m - 1} {D}_{i , j}^{2} ; and$$
$$Den = \frac{1}{m * n} {\sum }_{i = 1}^{n} {\sum }_{j = 0}^{m - 1} \frac{1}{{D}_{i , j}^{2}}$$
wherein n represents the number of all the clusters, m represents the number of feature points in a cluster, and both m and n are positive integers; i and j represent the index of a cluster and the index of a mismatching feature point in a cluster, respectively; and D_{i,j}=\sqrt{(x_{i,j}−x_{i,0})²+(y_{i,j}−y_{i,0})²}, wherein (x_{i,0}, y_{i,0}) represents the coordinates of the central point of the i^{th} cluster, (x_{i,j}, y_{i,j}) represents the coordinates of the j^{th} feature point in the i^{th} cluster, D_{i,j} represents the distance of the j^{th} feature point in the i^{th} cluster to the cluster center (x_{i,0}, y_{i,0}) of the i^{th} cluster, and K_{i,j} represents a weight coefficient related to D_{i,j}.

18. The image processing apparatus for tamper proofing according to claim 14, wherein the tamper determining unit comprises:
a second clustering sub-unit configured to perform cluster analysis on the mismatching feature points; and
a second tamper determining sub-unit configured to determine that the image to be detected has been tampered with relative to the original image if the clusters obtained by the second clustering sub-unit comprise at least one cluster in which the number of the mismatching feature points in a region which is centered on the center of the cluster and has a predetermined size is larger than a predetermined second threshold.

19. A program product comprising non-transitory machine readable instruction codes stored therein, wherein the instruction codes, when read and executed by a machine, are capable of causing the machine to execute an image processing method for tamper proofing, the method comprising:
acquiring a first robust feature representation of a first set of robust feature points for an original image and a second robust feature representation of a second set of robust feature points for an image to be detected, respectively;
matching the first robust feature representation with the second robust feature representation so as to acquire mismatching feature points; and
determining whether the image to be detected has been tampered with relative to the original image based on a distribution characteristic of the mismatching feature points.

20. A non-transitory machine readable storage medium with a program product carried thereon, wherein the program product comprises machine readable instruction codes stored therein, wherein the instruction codes, when read and executed by a machine, are capable of causing the machine to execute an image processing method for tamper proofing, the method comprising:
acquiring a first robust feature representation of a first set of robust feature points for an original image and a second robust feature representation of a second set of robust feature points for an image to be detected, respectively;
matching the first robust feature representation with the second robust feature representation so as to acquire mismatching feature points; and
determining whether the image to be detected has been tampered with relative to the original image based on a distribution characteristic of the mismatching feature points.
